(19) United States
(12) Patent Application Publication
(10) Pub. No.: US 2011/0299360 A1
(43) Pub. Date: Dec. 8, 2011

(54) SEISMIC ARRAY WITH SPACED SOURCES HAVING VARIABLE PRESSURE

(76) Inventors: Roy Malcolm Lansley, Bellville, TX (US); Madjid Berraki, La Garde (FR); Michel Marc Maurice Gros, La Roquebrussanne (FR)

(21) Appl. No.: 12/998,723

(22) PCT Filed: Sep. 21, 2007
(86) PCT No.: PCT/US07/20522

§ 371 Date: May 24, 2011

Related U.S. Application Data
(60) Provisional application No. 60/826,616, filed on Sep. 22, 2006.

(51) Int. Cl. G01V 1/38; G01V 1/137

(52) U.S. Cl. 367/20; 367/144

(57) ABSTRACT

An over/under seismic source system includes a first umbilical to a first gun array at a first depth and a second umbilical at a different air pressure to a second gun array at a second, lower depth. The air pressure to the second, lower gun array is tuned so that the periods of the gun bubbles from the higher and lower gun arrays match in order to improve wavefield separation in subsequent data processing.

This application claims the benefit of U.S. Patent Application Ser. No. 60/826,616 filed Sep. 22, 2006.

### FIELD OF THE INVENTION

The present invention relates generally to the field of seismic surveying and, more particularly, to a set of vertically spaced apart seismic sources for use in seismic surveying, including use with a towed array, as well as ocean bottom cables and node surveys, wherein the spaced apart sources operate at different pressures and volumes.

### BACKGROUND OF THE INVENTION

In conventional towed-streamer marine acquisition, a plurality of seismic streamers are towed behind a vessel at a desired depth. Each of the plurality of streamers comprises many sensors of one or more types to acquire seismic data, as well as a number of external devices such as birds to maintain the streamers at the desired depth and one or more sources to generate the seismic signals.

It is well known that shallow sources and cables increase the high-frequency content of the seismic data that is needed for resolution. However, this arrangement attenuates the low frequencies needed for stratigraphic and structural inversion. Towing the seismic streamers at a shallow depth also makes the data more susceptible to environmental noise, typically from the towing vessel and noise generated at the water surface from wave action, wind, rain, and other environmental sources.

Conversely, deep sources and deep cables enhance low frequencies, attenuate high frequencies, and the data has a higher signal-to-ambient-noise ratio due to a reduced susceptibility to environmental noise. Low frequency content of the seismic signal is important for penetration of deep geologic structures. A conventional towed-streamer survey design, therefore, attempts to balance these conflicting aspects to arrive at a tow depth for sources and receiver cables that optimizes bandwidth and signal-to-noise ratio for a target depth or two-way travel time, often at the expense of other shallower or deeper objectives.

An over/under, towed-streamer configuration acquires seismic data with cables towed in pairs at two different cable depths, with one cable above the other. In a similar manner, it is possible to acquire data with paired sources at two different source depths. However, in this situation there are two opposing effects that influence the frequency content of the signals generated by the sources. Sources operating at lower depths exhibit a higher natural frequency of bubble reverberation than sources at shallower depths, while the effect of the ghost reflection from the water-air interface emphasizes the lower frequencies. These effects thereby create a frequency mismatch in the signals generated by the over/under sources.

The over/under acquisition concept using wave field separation has been known and understood since the mid-1980s. The success of the wave field separation method depends on accurately maintaining the over/under streamers in the same vertical plane. In original systems, this requirement was too difficult to fulfill and consequently this very good geophysical idea was shelved for some time. Recent commercial applications of the over/under technique have been made possible by the development of steerable streamers. The control systems associated with these cables are capable of keeping them in horizontal and vertical alignment, one above the other, to within the small tolerance required for the method to work correctly.

In one known system, data from an over/under streamer and sources configuration are combined at the processing stage into a single dataset where both the lower source and streamer ghosts are removed. Thus, the resulting dataset has the high-frequency characteristics of conventional data, recorded at a shallow towing depth, and the low-frequency characteristics of conventional data, recorded at a deeper towing depth.

There are a number of benefits to over/under data compared to conventional data. First, significantly broader signal bandwidth with low-frequency content gives deeper penetration down into geologic structures underlying the ocean bottom, and therefore, improved imaging beneath basalt, salt and other highly absorptive overburdens. Moreover, the bandwidth extension to lower frequencies makes seismic inversion less dependent upon model-based methods. Second, if the over/under cable pair defines a vertical separation equal to the shallow tow depth of a conventional high-resolution configuration (typically less than six meters), and the closely spaced over/under cable pair were towed at depth (typically greater than fifteen meters), then the combined over/under dataset would have the high-frequency content given by the vertical cable separation and the low-frequency content delivered by the deep tow depth.

The over/under arrangement includes a number of other advantages. For example, a simpler signal wavelet with the bandwidth extension to higher frequencies gives enhanced resolving power and allows for a more detailed stratigraphic interpretation. The deeper towed-cable pairs provide a higher signal-to-ambient-noise ratio. In addition, the deeper towed-cable pairs enable an extended weather window. Finally, the over/under data may in future offer ocean-bottom-cable type multiple-attenuation schemes to towed streamer data and enable the removal of sea-surface effects from three-dimensional data, hence, improving four-dimensional repeatability.

The principles of the over/under source configuration follows those of the over/under cable. Two source arrays are deployed at different depths. Once again, the wave field separation method requires constant depths with constant vertical separation and no lateral separation between the geometrical centers of the arrays.

Unfortunately, in an over/under source configuration, the lower source is subjected to a higher hydrostatic pressure, resulting in a mismatch in the bubble period and the peak-to-bubble ratio as well of the higher (over) source and the lower (under) source.

Thus, there remains a need for an over/under system in which the signal profiles of the respective arrays can be tuned to eliminate this factor of interference between the signals. In this way, the upper and lower arrays can have identical wave shapes, resulting in a simpler operator for the wave field separation and therefore resulting in clearer images of the geological data.

### SUMMARY OF THE INVENTION

The present invention addresses these and other needs in the art by providing at least two seismic sources, spaced vertically apart, operating at different air pressures. In a preferred embodiment, a first umbilical feeds a first gun array at a first depth and a second umbilical at a different air pressure feeds a second gun array at a second, lower depth. The air pressure to the second, lower gun array is tuned so that the periods of the gun bubbles from the higher and lower guns match. In so doing, the unghosted signature of the lower source can be seen as a time delayed version of that of the upper source with a proportional amplitude due to the different pressure. Thus, the wave field separation operator becomes more suitable for subsequent data processing.

In another preferred embodiment, pairs of gun arrays, fed from independent umbilicals, are deployed in one array. The guns may be positioned vertically over one another, in which case the guns are fired simultaneously or very nearly simultaneously so that the downgoing signals from the respective sources are synchronized. Alternatively, the lower guns may be staggered in a vertically and horizontally displaced arrangement, in which case the lower guns are fired at a delayed time, depending on the speed of traverse of the arrays.

These and other features and advantages of this invention will be apparent to those of skill in the art from a review of the following detailed description along with the accompanying drawing figure.

### BRIEF DESCRIPTION OF THE DRAWINGS

FIG. 1 is a schematic drawing of a marine seismic system including over/under signal sources with independent umbilicals which operate at different pressures.

FIG. 2 is a schematic diagram of a presently preferred over/under signal source system in which the upper and lower sources are oriented along a vertical orientation for simultaneous firing of source arrays.

FIG. 3 is a detail view of the system of FIG. 2.

FIG. 4 is a schematic diagram of a presently preferred over/under signal source system in which the upper and lower sources are staggered for sequential firing of source arrays.

FIG. 5 is a schematic diagram illustrating seismic signal paths from a single source to an over/under seismic streamer.

FIG. 6 is a schematic diagram illustrating seismic signal paths from an over/under source configuration to a streamer.

FIG. 7 is a time plot depicting the mismatch in the bubble period from over and under sources operating at the same pressure and volume.

FIG. 8 is a frequency response plot showing unmatched amplitude spectra from the over and under sources operating and the same pressure and volume.

FIG. 9 is a time plot of an unghosted signature comparison of tuned sources in accordance with the present invention prior to scaling.

FIG. 10 is a time plot of an unghosted signature comparison of tuned sources in accordance with the present invention after scaling.

FIG. 11 is a plot of unghosted amplitude spectra of the present invention prior to scaling.

FIG. 12 is a plot of unghosted amplitude spectra of the present invention after scaling.

### DETAILED DESCRIPTION OF A PREFERRED EMBODIMENT

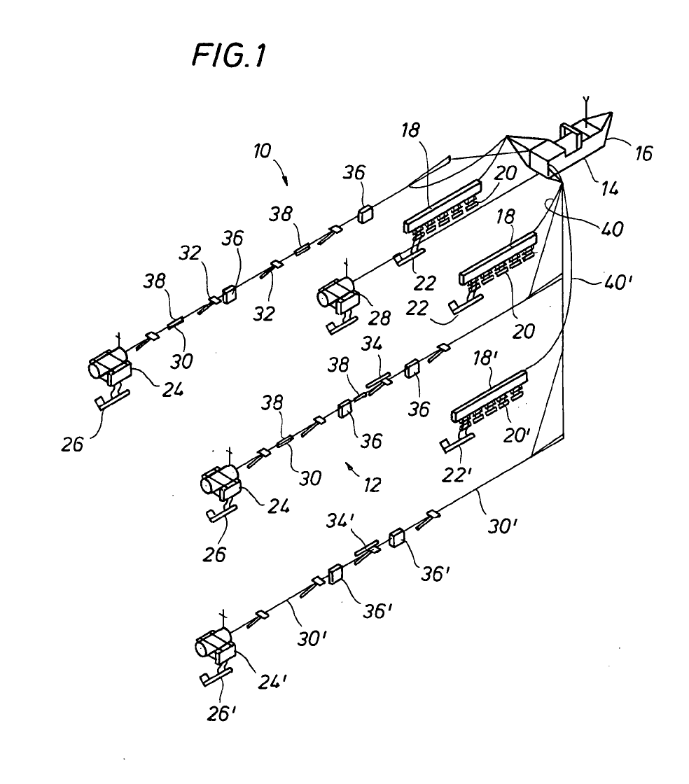

The system depicted in FIG. 1 is a data acquisition and control system 10 designed for marine seismic operations, including an over/under signal arrangement in accordance with the present invention, as described in greater detail below. The system includes a shipboard controller 14 aboard a vessel 16 and in-water remote units 12.

The in-water remote units 12 include air gun arrays 18, which may be of many well known types. Accompanying each gun array 18 is a set of gun acoustic units 20 and associated tow fish acoustic units 22 deployed below. The system also includes a tail buoy 24 and an associated tow fish acoustic unit 26 at the end of each streamer 30, for example.

The system may also include a tow buoy 28 and either a gun acoustics unit or a surface mount unit. The gun acoustics unit provides precise location of the seismic energy source relative to a fixed reference point, while the surface mount acoustic unit is used in locations where the use of streamer-mounted remote units would be impractical.

Spaced along each streamer is a plurality of depth control devices 32, commonly referred to as birds. A depth control device 32 may also include a float tube 34 attached to it. Also spaced along each streamer is a set of modules 36. The modules provide coupling for high data rate transmission of seismic data and telemetry accumulated by the appropriate external devices. Finally, spread out along each section of streamer 30 are disposed a plurality of hydrophones 38 to receive seismic signals, perhaps thousands of such hydrophones 38. It is to be understood that the present invention is equally applicable to other types of sensors and deployment configurations.

To this point, the system shown and described is similar to that of Chien, U.S. Pat. No. 6,011,753, incorporated herein by reference. However, in the present invention, an air gun array 18′, which may also be of many well known types, is deployed below the air gun array 18 in a vertically spaced apart relation thereto. It is to be understood that a corresponding gun array is included along the port side streamer but is not illustrated in FIG. 1 for purposes of simplicity of illustration. Accompanying each gun array 18′ is a set of gun acoustic units 20′ and associated tow fish acoustic units 22′ deployed below.

The gun array 18 is provided with an umbilical 40, which provides among other things a supply of compressed air at a first air pressure. The gun array 18′ is also provided with an umbilical 40′ to supply the gun array with compressed air at a different pressure than that provided to the shallower gun array 18. In this way, the acoustic signature provided by the run array 18′ can be tuned to match the acoustic signature of the gun array 18, despite the greater hydrostatic pressure at the gun array 18′. The umbilicals 40 and 40′ also include command and control signal conductors to control the timing of the firing of the guns in the respective arrays.

The system also includes an under streamer 30′, including the same external devices as the over streamer 30, but operating at a lower depth.

It is also to be understood that other orientations and structures may be used to provide the lower seismic signal source with a different pressure than that of the higher seismic signal source. For example, a single umbilical may be used, providing the different pressure air to the lower source, then a feed line run to the higher source, with a tunable pressure regulator included in the feed line.

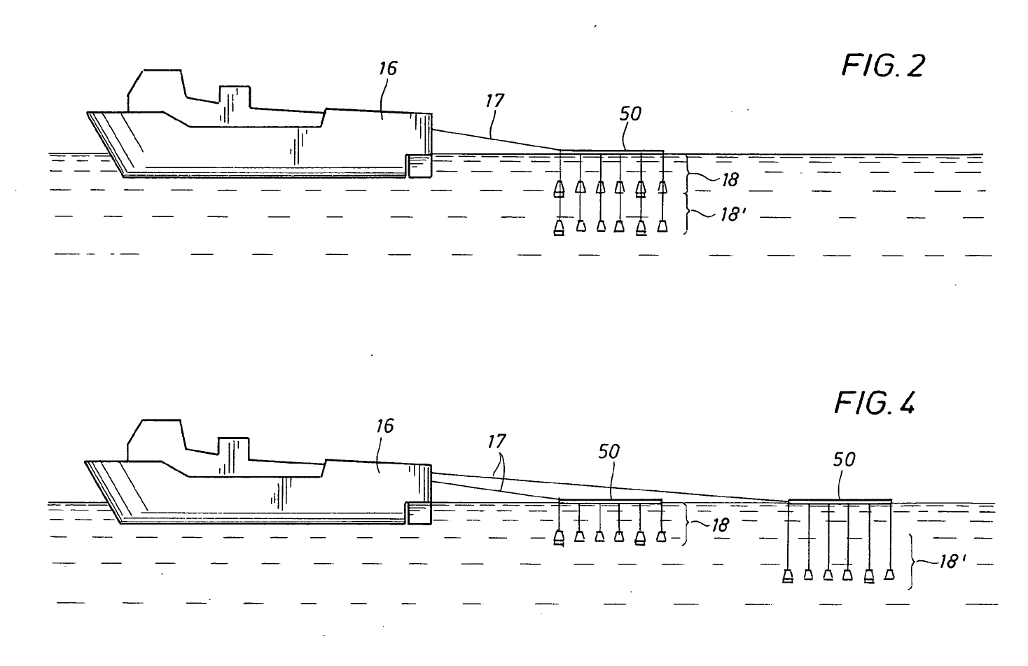

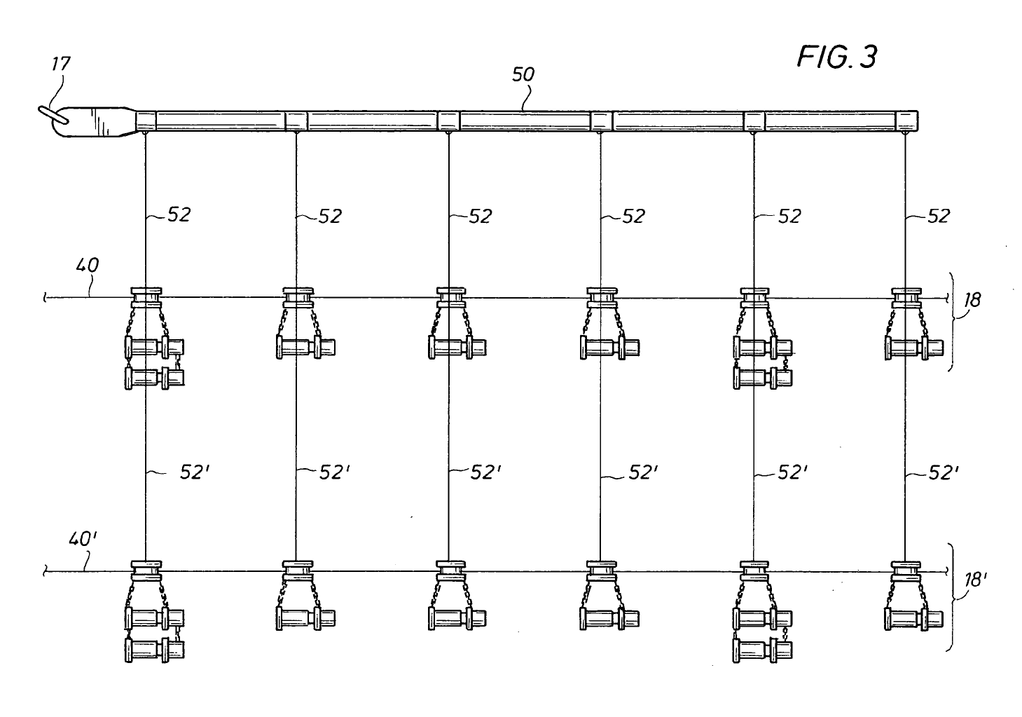

Such an arrangement is depicted in FIG. 2 and FIG. 3. The source array of FIG. 2 comprises an over arrays 18 and an under array 18′. The arrays are towed behind the vessel 16 by a tow cable 17, which includes the stress members to secure the arrays the vessel, as well as power, communications conductors, and air hoses. Referring more specifically to FIG. 3, the over array 18 and the under array 18′ are coupled to a towed carriage 50 which is pulled by the two cable 17. In this instance, a first umbilical 40, supplied at a first air pressure, feeds compressed air to the over array 18, and a second umbilical 40′ feed compressed air to the under array 18′ at a second pressure. It is to be understood that one umbilical could be provided to both arrays, with an air pressure regulator between them to vary the air pressure from the under array to the over array. A series of lanyards 52 secures the over array 18 of guns to the carriage 50 and a series of lanyards 52′ secures the under array 18′ of guns to the carriage 50.

Finally, FIG. 4 illustrates a presently preferred embodiment, wherein the over array 18 is staggered horizontally from the under array 18′. In this arrangement, the gun arrays are triggered sequentially so that the source locations match geographically.

### Over-Under Towed Streamers

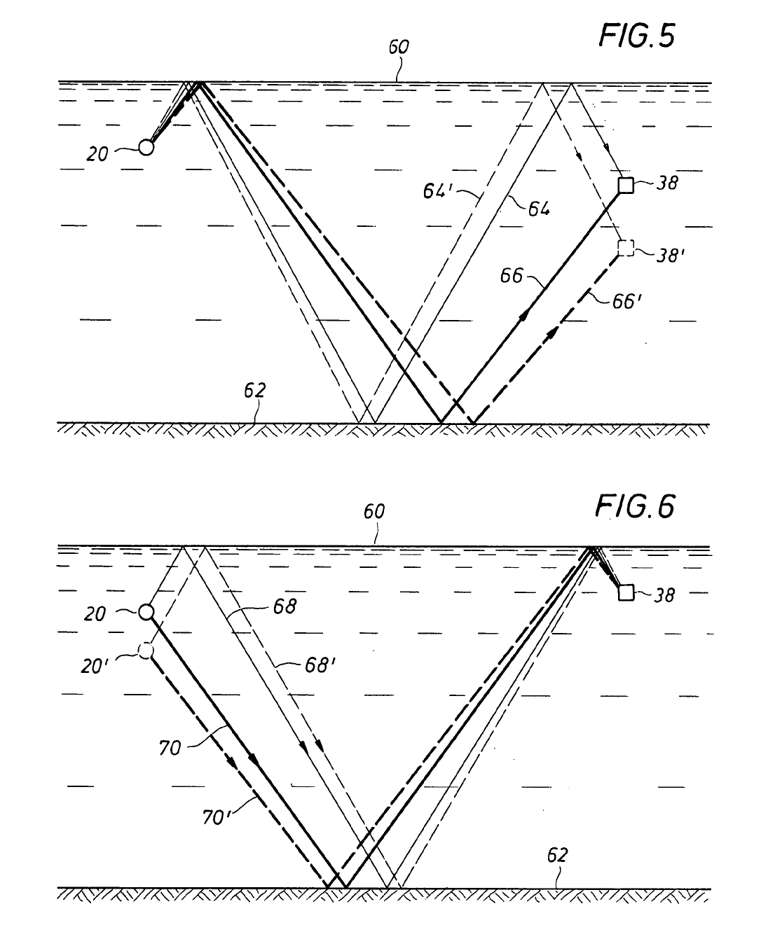

Now that the structure of the present invention has been described in detail, the advantages of the present invention will be more fully understood from a review of the following illustrations. FIG. 5 illustrates the seismic signal ray paths from a source (gun unit) 20 toward an over sensor 38 and an under sensor 38′, as previously described. The ray paths are reflected by the air/water interface at a sea surface 60 and a bottom reflecting surface 62, as shown. The signals that are received by the sensors 38 and 38′ are made up of downgoing waves 64 and 64′ and upgoing waves 66 and 66′.

Considering the ray paths displayed in FIG. 5, seismic wavefields R^{Over} and R^{Under} can be written as the sum of an up-going wavefield and a down-going wavefield:

R^{Over}=(R^{Over})ᵤₚ+(R^{Over})_{down} (1)

R^{Under}=(R^{Under})ᵤₚ+(R^{Under})_{down} (2)

The wavefield separation technique consists in finding the unghosted part of the wavefield, say (R^{Over})ᵤₚ. The upcoming wavefield at the over streamer 38 is received later than at under streamer because it has traveled through an extra thickness of water, Δz. Similarly, the downgoing wavefield at under streamer 38′ is received later than at over streamer. Provided that the over streamer and the under streamer can be kept vertically paired, wavefields at the different depths can be related using a wave extrapolator W (angle-dependent time-shifting filters). Thus, the wavefield components at different depths can be expressed as

(R^{Over})ᵤₚ=W×(R^{Under})ᵤₚ (3)

(R^{Under})_{down}=W×(R^{Over})_{down}, (4)

W=exp(jk_{z}Δz) (5)

in which W is the wave extrapolator that depth advances up-going waves or depth delays down-going waves over a thickness of |Δz|, k_{z} denotes the spatial frequency over the depth axis and j is the complex imaginary unit.

Now, inserting equations (3) to (5) into equations (1) and (2) and noting that

W⁻¹=W* (6)

where the superscript * denotes the complex conjugate, the separated wavefields are given by

$$\begin{matrix}{( {R}^{Over} )}_{up} = \frac{{WR}^{Over} - {R}^{Under}}{W - {W}^{*}} & ( 7 ) \\ {( {R}^{Over} )}_{down} = - \frac{{W}^{*} {R}^{Over} - {R}^{Under}}{W - {W}^{*}} & ( 8 )\end{matrix}$$

The numerator involves subtracting the deeper wavefield from the depth-shifted shallow wavefield; this is equivalent to a ghost which notch corresponds to the separation between the two streamers. Furthermore, the denominator represents an optional deconvolution of this new ghost.

### Over-Under Sources

The principles of the over/under source configuration, as shown schematically in FIG. 6, follow those of the over/under cable. Two source arrays are deployed at different depths; again, the wave field separation method requires constant depths with constant vertical separation and no lateral separation between the geometrical centers of the arrays.

Considering that the over-under streamer combination has been achieved for each source, FIG. 6 displays the ray paths for an over-under source configuration. for an over-under towed source configuration. The ghosted input signals are shown in FIG. 6 as ray 68 and ray 68′, and the unghosted input signals are shown as rays 70 and 70′.

For any seismic response R and any input signal S, the Green's function G is defined as follows:

R=G*S (9)

Introducing equation (9) into equation (7), seismic response induced by the over and the under source can be written as follows:

$$\begin{matrix}{[ {( {R}^{OverStreamer} )}_{up} ]}^{OverSource} = \frac{{WG}^{OverStreamer} - {G}^{UnderStreamer}}{W - {W}^{*}} {S}^{Over} & ( 10 ) \\ {[ {( {R}^{OverStreamer} )}_{up} ]}^{UnderSource} = \frac{{WG}^{OverStreamer} - {G}^{UnderStreamer}}{W - {W}^{*}} {S}^{Under} & ( 11 )\end{matrix}$$

Where G^{Over Streamer} and G^{Under Streamer} are the Green's function at the over and under streamer level respectively.

Seismic inputs S^{Over} and S^{Under} are sums of a unghosted part (downgoing wavefield) and a ghost (upgoing wavefield).

S^{Over}=(S^{Over})_{unghosted}+(S^{Over})_{ghost} (12)

S^{Under}=(S^{Under})_{unghosted}+(S^{Under})_{ghost} (13)

Provided that constant towing depths with constant vertical separation and no lateral separation between the geometrical centers of the arrays can be achieved, the different components of S^{Over} and S^{Under} are related so that

(S^{Over})_{unghosted}=Y×exp(jk_{z}Δzs)×(S^{Under})_{unghosted}, (14)

(S^{Under})_{ghost}=Y×exp(jk_{z}Δzs)×(S^{Over})_{ghost} (15)

where Y is the source extrapolator and Δzs is the sources' vertical separation.

Then introducing equations (14) to (15) into equations (12) and (13), the following relationship is established:

$$Y \times {[ {( {R}^{OverStreamer} )}_{up} ]}^{OverSource} - {[ {( {R}^{OverStreamer} )}_{up} ]}^{UnderSource} = [ \frac{{WG}^{OverStreamer} - {G}^{UnderStreamer}}{W - {W}^{*}} ] [ Y - {Y}^{*} ] {( {S}^{Over} )}_{unghosted} \qquad ( 16 )$$

The term [Y−Y*] is equivalent to a ghost which notch corresponds to Δzs. Thus, as long as the unghosted far-field signature of the sources are known, equation (16) provides a means to combine over and under source datasets so that over and under source ghosts are removed.

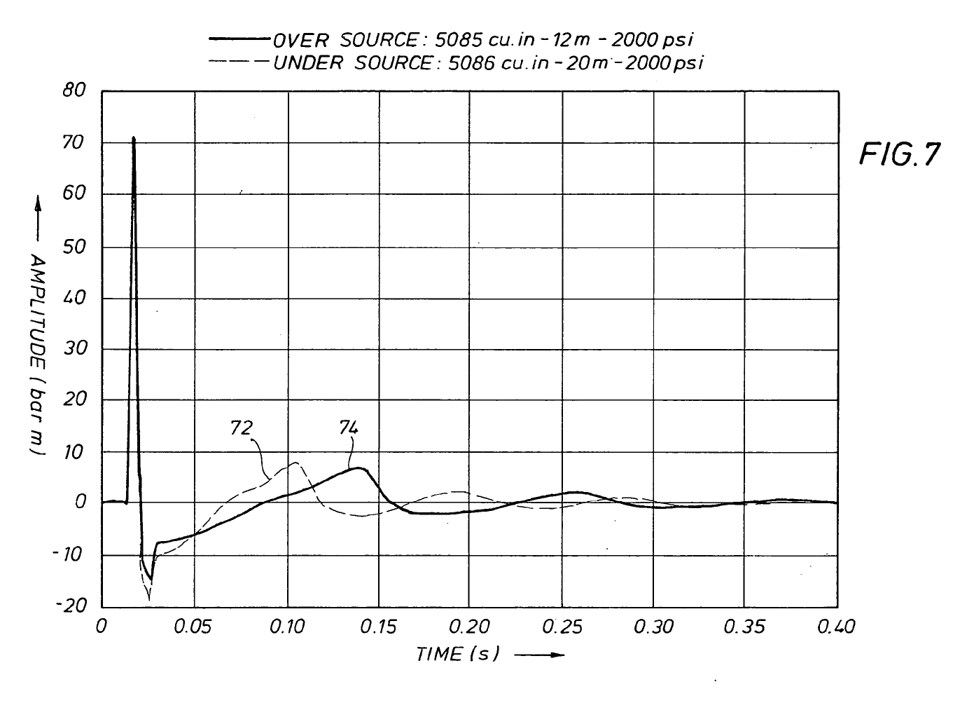

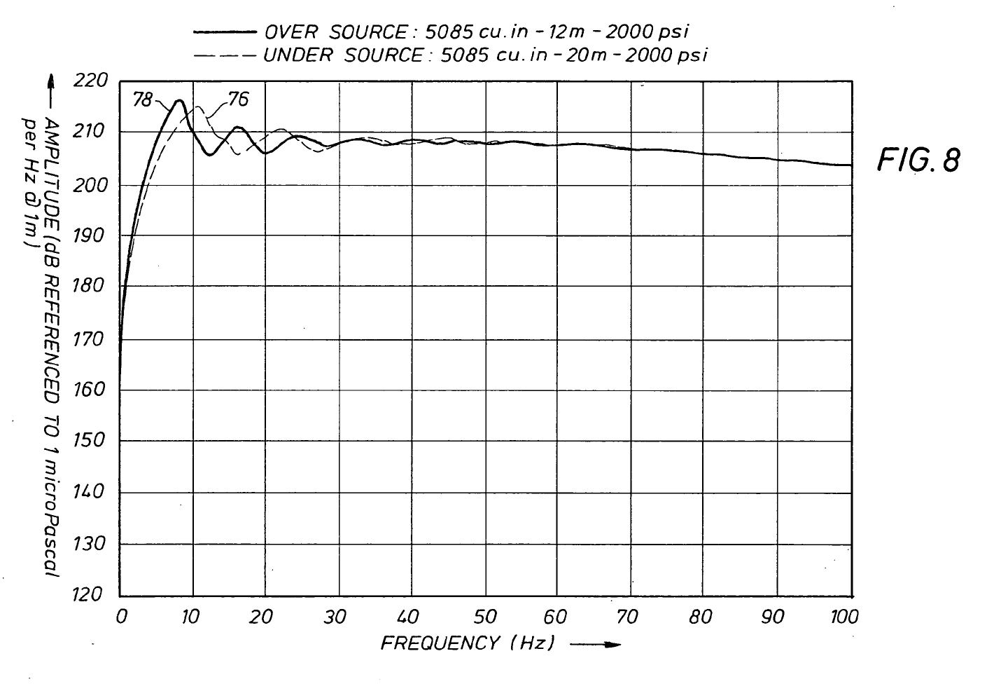

In previous systems, over and under sources have the same volume and pressure; because the under source is subjected to a higher hydrostatic pressure, its spectrum is quite different from the over source, as shown in FIGS. 7 and 8, leading to an intricate expression for the source extrapolator Y. In FIG. 7, trace 72 illustrates the time response of the under source with a 5085 in³ shot at a depth of 20 meters at 2000 psi. The trace 74 is for the over source as 12 meters, at the same volume and pressure. In FIG. 8, trace 76 shows the frequency response for the under source and trace 78 shows the frequency response for the over source, with the data as described in respect of FIG. 7.

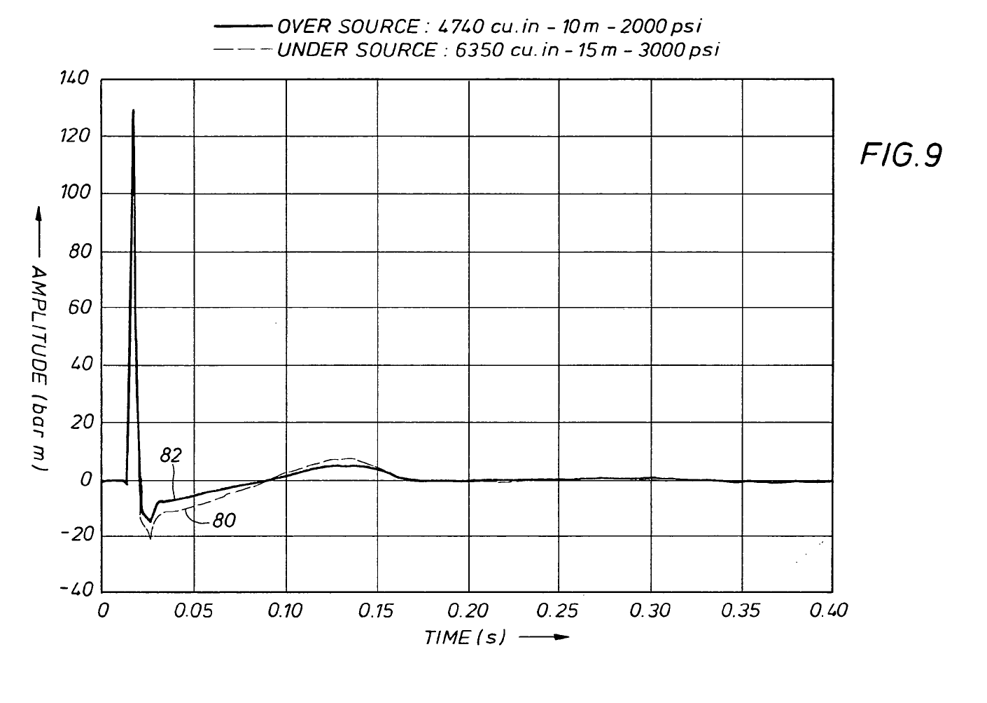

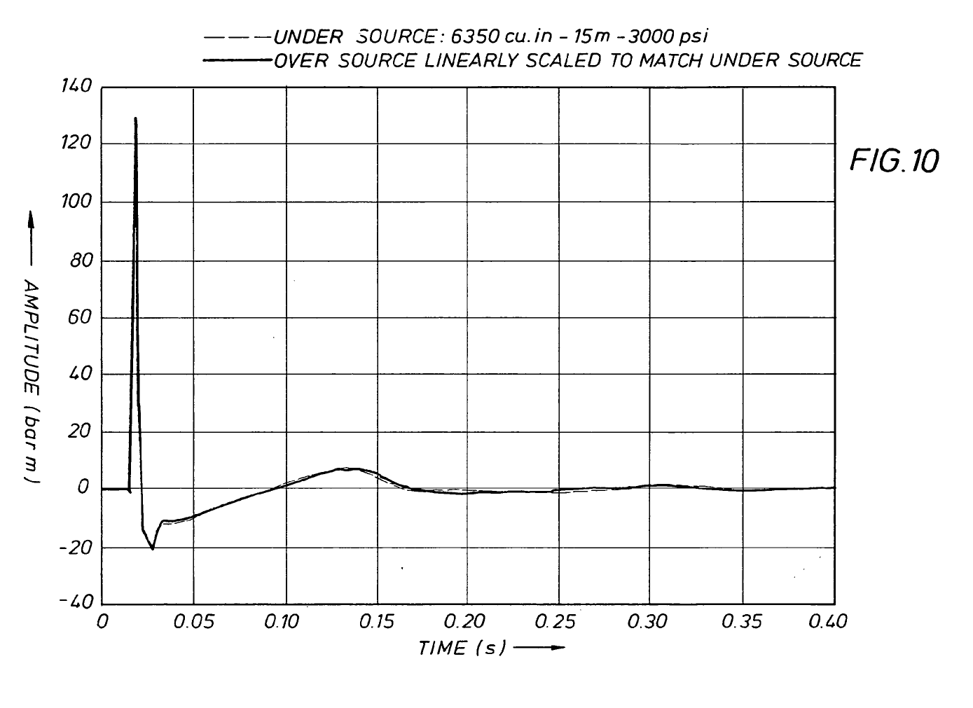

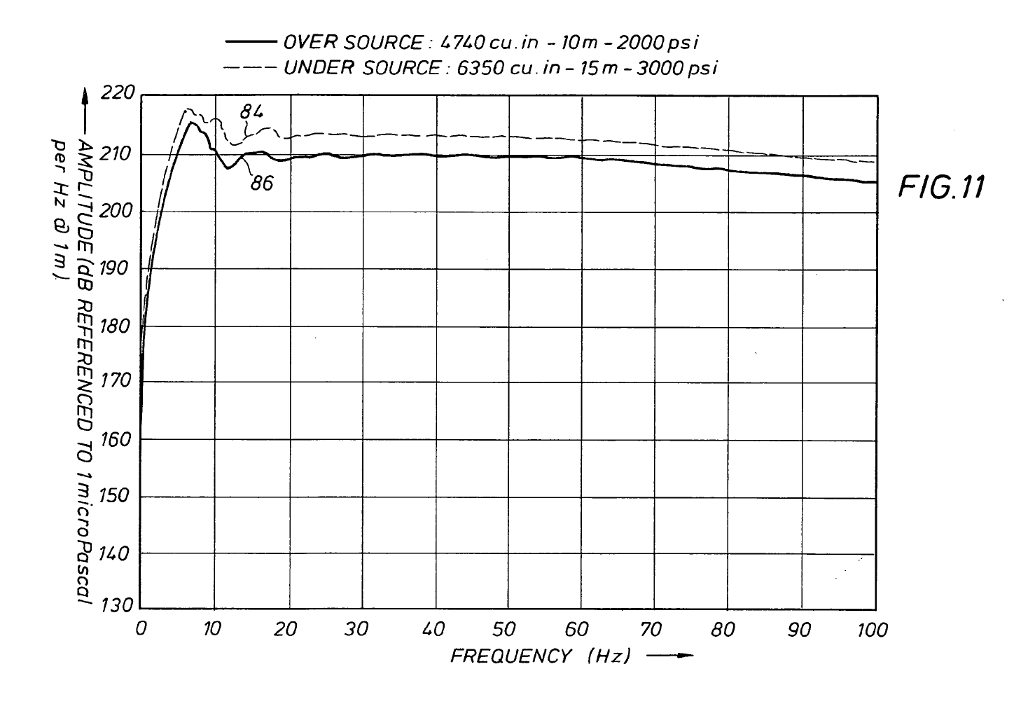

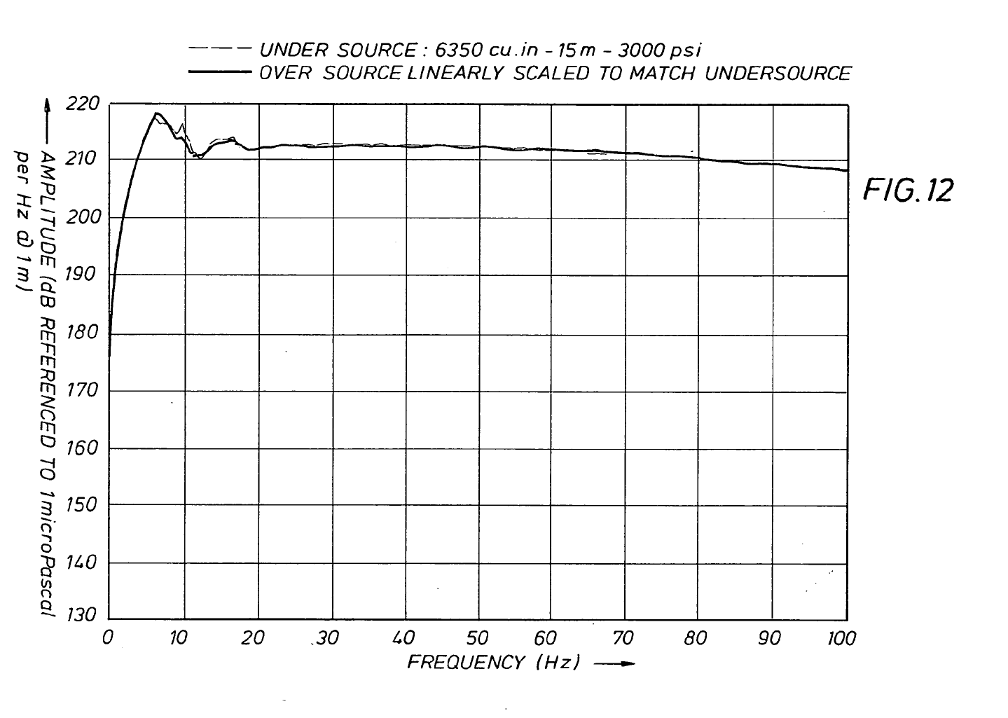

In contrast, the present invention provides for matching the wave shapes of the over and under sources, resulting in a simpler operator for the wave field separation and therefore in clearer images of the geological data. This can be achieved by tuning the under sources so that the periods of the gun bubbles from the higher and lower guns match, as shown in FIGS. 9, 10, 11, and 12. In FIG. 9, trace 80 illustrates the time response of the under source with a 6350 in³ shot at a depth of 15 meters at 3000 psi. while trace 82 shows the time response of the over source with a 4740 in³ shot at a depth of 10 meters at 2000 psi. In FIG. 11, trace 84 illustrates the frequency response from the under source and trace 86 illustrates the frequency response from the over source, with the conditions as described above in respect of FIG. 9.

In so doing, not only volumes but firing pressures may be modified, and then the unghosted signature of the under source can be seen as a time delayed version of that of the over source with a proportional amplitude A due to the different pressure and volume; in other words, the source extrapolator can be written as

Y=A·exp(jk_{z}Δzs). (17)

Such an expression for Y greatly simplifies the implementation of equation (16).

By now, it should be evident that the over/under source configuration of the present invention find application in a variety of sensor configurations, including towed cable sensor arrays. However, the sensors may alternatively be mounted in autonomous seafloor nodes or they may be deployed in a well borehole.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

We claim:

1. An over/under seismic source system comprising:
a. a first gun array at a first depth operating at a first air pressure for generating a first seismic signal; and
b. a second gun array at a second, lower depth operating at a second, different air pressure for generating a second seismic signal.

2. The source system of claim 1, further comprising means for actuating the first and second gun arrays so that the first and second seismic signals are synchronized.

3. The source system of claim 1, further comprising means for actuating the first and second gun arrays sequentially.

4. The source system of claim 1, wherein the first and second gun arrays are vertically arranged one over the other.

5. The source system of claim 1, wherein the first and second gun arrays are horizontally staggered from one another.

6. The source system of claim 1, further comprising a towing apparatus to tow the source system behind a vessel.

7. The source system of claim 1, further comprising a first umbilical mechanically coupled to the first gun array and a second umbilical mechanically coupled to the second gun array.

8. A seismic system comprising:
a. a plurality of seismic sensors;
b. a plurality of gun arrays, at least two of the plurality of gun arrays vertically spaced apart; and
c. a separate umbilical to each of the least two of the plurality of gun arrays, the separate umbilicals carrying air at different pressures.

9. The seismic system of claim 8, wherein the sensors are mounted in towed arrays.

10. The seismic system of claim 8, wherein the sensors are mounted in ocean bottom cables.

11. The seismic system of claim 8, wherein the sensors are mounted in autonomous seafloor nodes.

12. The seismic system of claim 8, wherein the sensors are deployed in a well borehole.
